(19) United States
(12) Patent Application Publication
(10) Pub. No.: US 2014/0024764 A1
(43) Pub. Date: Jan. 23, 2014

(54) MOULDING OF FIBRE REINFORCED THERMOPLASTIC MATERIALS

(71) Applicant: Ansie Du Toit, Southern Paarl (ZA)

(72) Inventor: Pieter Wouter Du Toit, Southern Paarl (ZA)

(21) Appl. No.: 13/823,423

(22) PCT Filed: Sep. 8, 2011
(86) PCT No.: PCT/IB2011/053925

§ 371 Date: Aug. 15, 2013

(30) Foreign Application Priority Data
Sep. 15, 2010 (ZA) 2010/06604
Oct. 22, 2010 (GB) 1017926.5

(51) Int. Cl. B29C 45/00; C08K 3/04; C08K 3/40

(52) U.S. Cl. CPC B29C 45/0005; C08K 3/40; C08K 3/04
USPC 524/494; 264/328.18; 524/495

(57) ABSTRACT

A process is provided for manufacturing articles though injection moulding of thermoplastic material and fibres. The fibres include glass fibres and are present in the moulded article in a quantity of 25% to 50%, by mass. More than 70% of the fibres have a length exceeding 5 mm in the moulded article. The thermoplastic material has a Notched Izod Impact Strength, after being combined with said fibres, greater than 250 J/m at 23 degrees Celsius.

### FIELD OF THE INVENTION

This invention relates to the moulding of fibre reinforced thermoplastic materials with improved mechanical properties.

### BACKGROUND TO THE INVENTION

Fibres have been used to enhance the mechanical properties of injection moulded thermoplastic materials, but the addition of fibres per se, does not necessarily result in an improvement in mechanical properties.

By way of example, virgin, un-reinforced thermoplastics such as polypropylene (PP) co-polymer or high density polyethylene (HDPE) have intrinsically high impact strength, e.g. Notched Izod Impact Strengths exceeding 6 J/cm and with the addition of short glass fibres at say 30%, by mass, the stiffness (flexural modulus) of the materials can be improved, but their impact strength will be reduced to 1.5-1.8 J/cm. If less glass fibre were added, e.g. only 5%, by mass, the impact strength of the reinforced thermoplastic would not be as low and would be closer to the high impact strengths of unreinforced thermoplastics, but the reinforced thermoplastic would also not have the desired stiffness, which is crucial in many applications, such as pallets for the transport and handling of goods, automotive parts, and the like.

Further, the addition of sufficient fibre to thermoplastics (e.g. about 50%, by mass) for significant improvement of its mechanical properties (including tensile strength, flexural modulus and impact strength), usually holds the disadvantages that the high fibre content of the reinforced polymer increases its viscosity in the molten state and requires high injection pressures when injection moulding these materials.

The present invention seeks to provide for the injection moulding of articles, using reinforced thermoplastic materials having improved mechanical properties over what is known in the prior art, moving closer to “no break” impact properties when exposed to harsh handling or nature's elements on a daily basis, substantially without sacrificing stiffness and tensile properties required for such structural components, and without increasing the fibre contents to the extent that injection moulding becomes prohibitively expensive. In particular, the invention seeks to provide for the injection moulding of articles, with a Notched Izod Impact strength of over 250 J/m, preferably 300 J/m or more, while still having a high tensile strength and flexural modulus.

### SUMMARY OF THE INVENTION

According to a first aspect of the present invention there is provided an injection moulded article comprising a thermoplastic material and fibres:
wherein said fibres are present in the moulded article in a quantity of 25% to 50%, by mass;
wherein more than 70% of said fibres have a length exceeding 5 mm in the moulded article; and
wherein said thermoplastic material has a Notched Izod Impact Strength, after being combined with said fibres, greater than 250 J/m at 23 degrees Celsius.

According to another aspect of the present invention there is provided a process for manufacturing an article, said process comprising:
preparing a composition by combining a thermoplastic material and fibres such that the composition includes 25% to 50% of said fibres, by mass; and
moulding said article by injection moulding;
wherein said thermoplastic material has a Notched Izod Impact Strength greater than 250 J/m at 23 degrees Celsius; and
wherein more than 70% of said fibres have a length exceeding 5 mm after injection moulding.

More than 50% of said fibres may have a length exceeding 10 mm, in the moulded article.

Said fibres may include glass fibre and/or carbon fibre.

The thermoplastic may include a polyolefin such as polypropylene, a polyester such as Polyethylene terephthalate (PET), or an engineering polymer such as Nylon, Polycarbonate or Acrylonitrile butadiene styrene (ABS).

### EXAMPLES

For a better understanding of the present invention, and to show how the same may be carried into effect, the invention will now be described by way of non-limiting examples.

### Method 1

PP was reinforced with long glass fibre (LGF), i.e. glass fibre with a fibre length of 5 mm or more, preferably 10 mm or more in a Direct Long Fibre Technology (D-LFT) process and moulded with a process using large injection moulding gates (the “Lomold” process) into a component. The nominal glass fibre content of the PP reinforced with glass fibre was 28% by weight. The PP and additives were fed at the back of a twin screw extruder and mixed thoroughly before the continuous glass fibre rovings were fed into last third of a 60 mm twin screw extruder (TSE). The continuous fibre rovings were drafted from free standing bobbins, through an infrared heated section and through a slot in the barrel of the TSE into the pre-molten and mixed polymer blend in the TSE. The continuous glass fibre rovings were cut by the screw and barrel interaction into shorter lengths, with 70% of the fibres entering the mould having a length exceeding 5 mm.

The test parts were moulded on a 180 ton Chuan Lih Fa Machinery Works Co. Ltd injection moulding machine converted to the Lomold process.

The PP used was an 80 MFI (melt flow index) material with a density of 0.906 g/cm3 and the glass fibre was Owens Corning Vetrotex SE 4121.

### Method 2

In another approach, PP reinforced with 40% by weight long glass fibre pultruded pellets with a length of 25 mm were mixed with PP in a ratio of 75% by weight of the long glass fibre pultruded pellets and 25% by weight of the PP to realise a thermoplastic material with a nominal glass fibre content of 30%, by weight. This mixture was then plasticized on a special three zone single screw plasticizer with a compression ratio less than 2.2. The screw did not have a valve and fed material directly into the Lomold metering cylinder (as described in International Patent Application No. WO 2007/049146). The same materials have been used to produce the PP glass fibre reinforced, pultruded pellets. Similar results as noted in the table below were achieved.

Additional trials were conducted with different fibre contents. The results are shown in the table below.

| | Notched Izod | Tensile Strength | Flexural Modulus |
|---|---|---|---|
| Material | (J/m) | (MPa) | (MPa) |
| Current Invention | | | |
| 21% LGF-PP | >200 | >85 | >5500 |
| 28% LGF-PP | >260 | >100 | >6800 |
| 36% LGF-PP* | >300 | >120 | >8000 |

*The ideal impact strength of LGF-PP is >300 J/m Notched Izod

From these results, it can be seen that injection moulded articles produced in accordance with the present invention had the desired impact, tensile and stiffness properties, as required, for example in automotive, transport, packaging applications, with a relatively modest glass fibre loading well below 50%, by mass. This can largely be attributed to the long lengths of the reinforcing glass fibres, preferably longer than 10 mm on average, which, in turn, result from the manufacturing methods implemented.

1. An injection moulded article comprising a thermoplastic material and fibres:
wherein said fibres include glass fibres and are present in the moulded article in a quantity of −30% to 50%, by mass;
wherein more than 70% of said fibres have a length exceeding 5 mm in the moulded article; and
wherein said thermoplastic material has a Notched Izod Impact Strength, after being combined with said fibres, greater than 270 J/m at 23 degrees Celsius.

2. An injection moulded article as claimed in claim 1, wherein said fibres include carbon fibre.

3. An injection moulded article as claimed in claim 1, wherein said thermoplastic material includes a polyolefin.

4. An injection moulded article as claimed in claim 3, wherein more than 50% of said fibres have a length exceeding 10 mm.

5. An injection moulded article as claimed in claim 1, wherein said thermoplastic material includes a polyester.

6. An injection moulded article as claimed in claim 1, wherein said thermoplastic material includes an engineering polymer.

7. A process for manufacturing an article, said process comprising:
preparing a composition by combining a thermoplastic material and fibres such that the composition includes 30% to 50% of said fibres, by mass; and
moulding said article by injection moulding;
wherein said fibres include glass fibres;
wherein said thermoplastic material has a Notched Izod Impact Strength greater than 270 J/m at 23 degrees Celsius; and
wherein more than 70% of said fibres have a length exceeding 5 mm after injection moulding.

8. A process as claimed in claim 7, wherein said fibres include carbon fibre.

9. A process as claimed in claim 7, wherein said thermoplastic material includes a polyolefin.

10. A process as claimed in claim 9, wherein more than 50% of said fibres have a length exceeding 10 mm.

11. A process as claimed in claim 7, wherein said thermoplastic material includes a polyester.

12. A process as claimed in claim 7, wherein said thermoplastic material includes an engineering polymer.

13. An injection moulded article as claimed in claim 2, wherein said thermoplastic material includes a polyolefin.

14. An injection moulded article as claimed in claim 2, wherein said thermoplastic material includes a polyester.

15. An injection moulded article as claimed in claim 3, wherein said thermoplastic material includes a polyester.

16. An injection moulded article as claimed in claim 4, wherein said thermoplastic material includes a polyester.

17. An injection moulded article as claimed in claim 2, wherein said thermoplastic material includes an engineering polymer.

18. An injection moulded article as claimed in claim 3, wherein said thermoplastic material includes an engineering polymer.

19. An injection moulded article as claimed in claim 4, wherein said thermoplastic material includes an engineering polymer.

20. An injection moulded article as claimed in claim 5, wherein said thermoplastic material includes an engineering polymer.
